(19) United States
(12) Patent Application Publication
(10) Pub. No.: US 2014/0048159 A1
(43) Pub. Date: Feb. 20, 2014

(54) Slurry and Wash Liquid Distributor

(71) Applicants: Graeme Cooke, Carrara (AU); Tom Lawson, Carrara (AU); Mark Palmer, Carrara (AU); Andrew Foster, Carrara (AU)

(72) Inventors: Graeme Cooke, Carrara (AU); Tom Lawson, Carrara (AU); Mark Palmer, Carrara (AU); Andrew Foster, Carrara (AU)

(73) Assignee: MINERAL TECHNOLOGIES PTY LTD, North Ryde, New South Wales (AU)

(21) Appl. No.: 14/007,356

(22) PCT Filed: Apr. 30, 2012
(86) PCT No.: PCT/AU2012/000451

§ 371 Date: Oct. 18, 2013

(30) Foreign Application Priority Data
May 3, 2011 (CA) 2739048

(51) Int. Cl. B05C 11/00

(52) U.S. Cl. CPC B05C 11/00
USPC 137/561 R

(57) ABSTRACT

The present invention provides a distributor for distribution of a liquid to a mineral processing apparatus, the distributor including a housing formed by an outer wall and a central chamber formed by an inner wall and located in the housing, the central chamber being adapted to receive the liquid for distribution to distribution chambers located between the outside of the central chamber and an internal surface of the housing, characterised in that passage from the central chamber to respective ones of the distribution chambers is by means of respective apertures which are formed through a generally horizontally oriented surface formed as part of the inner wall.

### FIELD OF THE INVENTION

The present invention relates to distributors for use with slurries, washing liquids, slurry and washing liquid combinations, as are used in mineral processing apparatus to split a single feed into a multiple of feeds.

### BACKGROUND OF THE INVENTION

Slurry and washing liquid distributors are known and examples of these can be found in U.S. Pat. No. 6,527,125 to Outotec and Canadian patent application 2044980 to Spargo, to identify but a few.

There has been a need to provide the market with a distributor that works differently to those previously known.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a distributor for distribution of a liquid to a mineral processing apparatus, the distributor includes a housing formed by an outer wall and a central chamber formed by an inner wall and located in the housing, the central chamber being adapted to receive the liquid for distribution to distribution chambers located between the outside of the central chamber and an internal surface of the housing, characterised in that passage from the central chamber to respective ones of the distribution chambers is by means of respective apertures which are formed through or in a generally horizontally oriented surface which is part of the inner wall.

The distribution chambers can have a wider base section compared to their upper sections.

The distribution chambers can be of similar or the same size and are equally angularly spaced around the central chamber.

The housing can be formed with radially inwardly projecting walls which will, in the final assembly, form walls separating the distribution chambers.

The inner wall which forms said central chamber can include axially and or radially extending complementary shaped grooves to receive free ends of the radially inwardly projecting walls of the housing to thereby form the distribution chambers.

There can be provided a central inlet tube which delivers the liquid to a base of the central chamber.

The central inlet tube can be assembled from two or more tube parts.

The base of the central inlet tube can include horizontally directed openings for liquid to travel out of the inlet tube into the central chamber.

A flow path of said liquid into said central chamber is such that the liquid must pass through one or more cavities before accessing said apparatus.

The one or more cavities are radially spaced around the central inlet tube.

A flow path of the liquid into said central chamber can be such that the liquid must pass through a sieve before accessing or passing into the apertures.

The apertures can be located between 30% and 60% of the height of the inner wall, and most preferably at 40% to 50% of the height.

The liquid can exit said distribution chambers from a location in the base of said distribution chambers.

The liquid distributed can be any one or more of the following: slurry of mineral to be processed; washing liquid.

### BRIEF DESCRIPTION OF THE DRAWINGS

An embodiment or embodiments of the present invention will now be described, by way of example only, with reference to the accompanying drawings, in which:

FIG. 1 is a cutaway perspective view of a distributor;

FIG. 2 is an exploded view of the device of FIG. 1;

FIG. 3 is an underneath perspective view of the complete components of the device of FIGS. 1 and 2;

FIG. 4 is a cross-section perspective view of another distributor;

FIG. 5 is another cross-sectional cut away perspective view of the distributor of FIG. 4;

FIG. 6 is an exploded view of the device of FIGS. 4 and 5; and

FIG. 7 is a perspective exploded view of FIGS. 4 and 5.

### DETAILED DESCRIPTION OF THE EMBODIMENT OR EMBODIMENTS

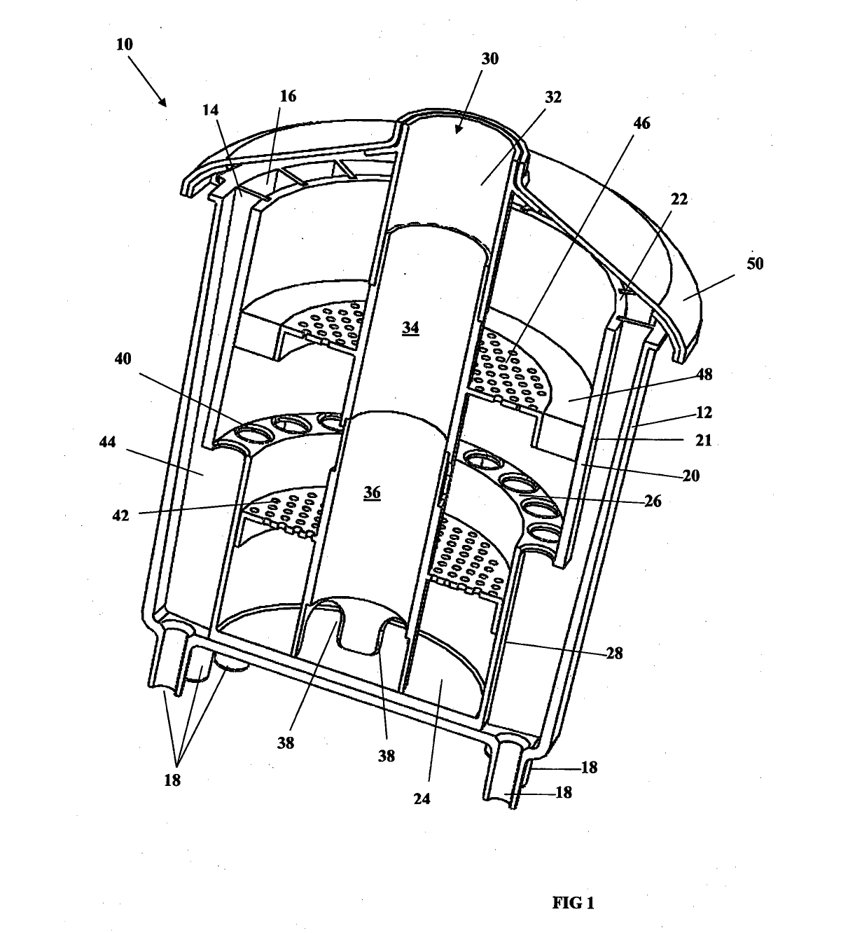

Illustrated in FIG. 1 is a distributor 10 which has main or outer housing 12 which includes radially inwardly directed walls 14 which form distribution chambers 16 arranged circumferentially around the inner surface of the housing 12. The chambers 16 are of generally equal dimensions with some twenty chambers 16 being provided, and each is open or vented at their top to assist with the even distribution of slurry or wash liquid out of the chamber, by assisting to prevent or minimise syphoning occurring.

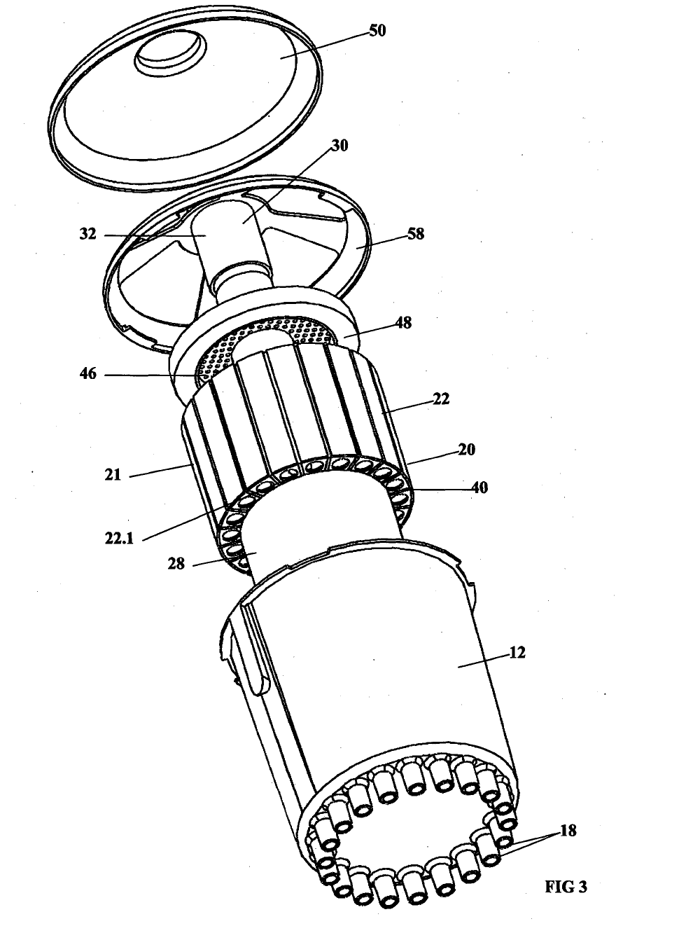

The base of each chamber 16 includes an outlet passage or fitting 18, which is best viewed in FIG. 3. Each chamber 16 is formed between side walls of adjacent walls 14, the inner wall of housing 12 and the outer surface of a central chamber 20. The central chamber 20 is formed by a bucket shape component which has an outer surface which serves as the inner wall of the distribution chambers 16, and an inner surface which forms the central chamber 20. The central chamber 20 has an upper section 21 of larger diameter than a lower section 28, and a base 24 forming a bucket like structure. Extending between the base of the upper section 21 and the top of the lower section 28 is a horizontal ledge or wall 26. In the horizontal ledge 26 is a series of twenty apertures 40 (one for each chamber 16), each of which allowing passage of liquid from the central chamber to respective distribution chambers 16. The apertures 40 exist in a horizontal plane. The horizontal ledge 26 is at approximately a height of 40% to 50% of the total height of the central chamber 20 or the inner volume thereof.

The central chamber 20 has the outside surface on its upper section 21 formed with a series of axially extending slots on its circumference which are sized, shaped and positioned so as to receive the free ends of the upper narrower part of segment walls 14. The horizontal or radially extending ledge 14.1 of the wall 14 will engage the horizontal or radially extending slot 22.1 on the underside of ledge 26, while the wider or inner lower wall 14.2 will engage the smooth outer surface of the outer circumference of lower section 28, thereby sufficiently sealing the sides and edges of the chambers 16. Thus the chambers 16 once formed have only outlets 18, apertures 40 and the upper opening through which liquid could pass. If desired, sealant could be used between the between wall 14.2 and the smooth side of the outer circumference of lower section 28.

Liquid enters the central chamber 20 via an inlet tube assembly 30. This assembly 30 has a tube portion 32 formed integrally with a circular locator formation 58, Which will sit on the upper rim of the housing 12 and will centrally locate the inlet tube assembly 30, relative to the housing 12. Joined to the tube section 32 is an intermediate tube section 34 to which is connected a lower tube section 36 which extends to the base 24 of the central chamber. In the base of the sections 34 and 36 are four radially outwardly directed openings 38 so that liquid which enters the distributor 10 via the inlet tube assembly 30 will flow downwardly and then outwardly there through.

It will be seen that both sections 34 and 36 have respective disc like platens 42 and 46 which have sieve holes therein. These help to impart a laminar flow to the liquid which is rising from the base 24 by positively disturbing turbulent flow which may be present. This also helps to prevent frothing which may impede the operation of the distributor, and overall improving distribution.

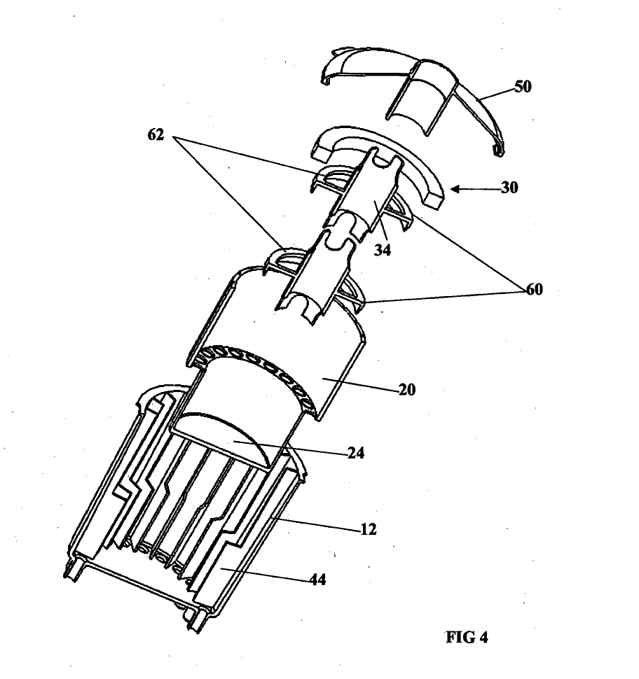

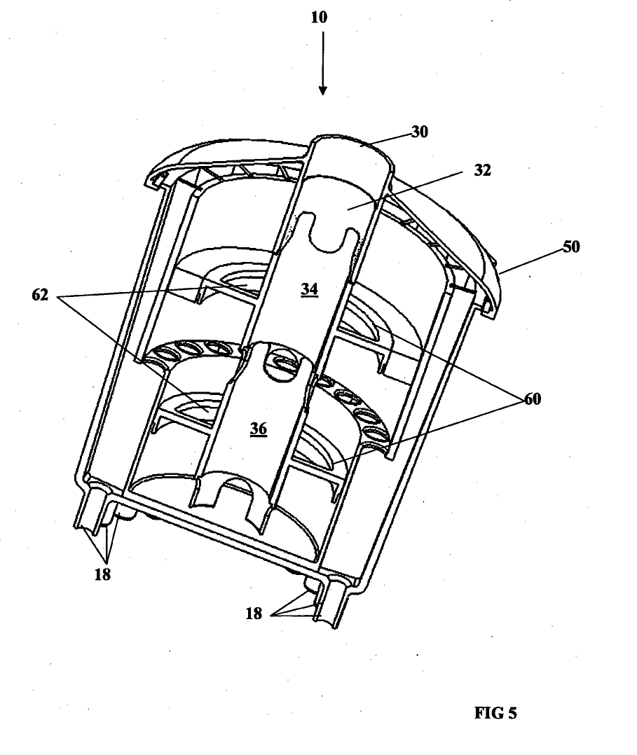

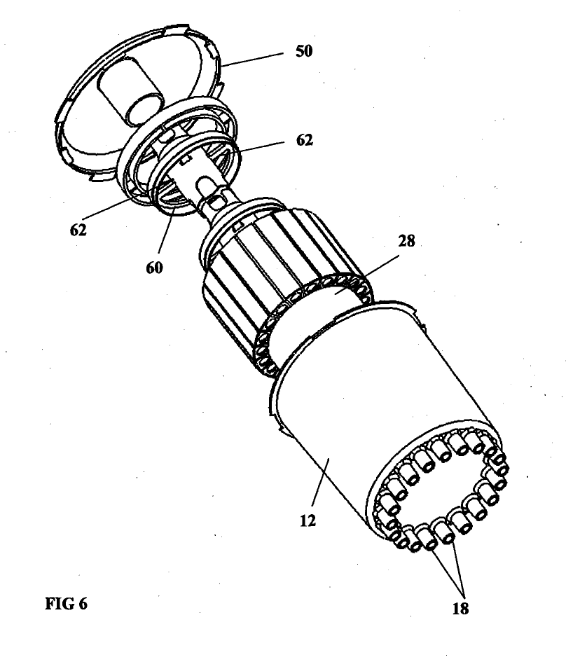

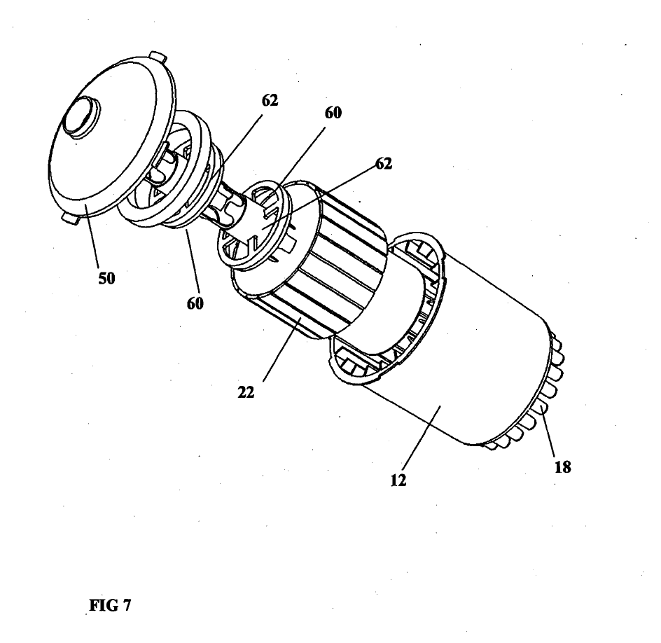

It will be appreciated that the respective disc like platens 42 and 46 do not need to include sieve holes and instead can include a spoke and aperture arrangement 60, as shown in FIGS. 4 to 7. In this arrangement, one or more apertures 62 are provided radially spaced around the tube section 34 of the inlet 30 in a wheel like arrangement. This decreases resistance to flow through the distributor which may be necessary in applications requiring higher throughputs.

The tube sections 34 and 36 are identical so as to reduce inventory. It will be noted that the upper section of the tube of section 36 receives the base of the tube of section 34.

As the diameter of upper section 21 is greater than the diameter of the lower section 28, a gasket 48 is provided between the platen 46 and the inner surface of central chamber 20.

Once the inner components are assembled, a cap 50 having a central aperture is placed over the formation 58 to prevent unwanted contamination of the liquid in the distributor. Further, the cap allows an operator to lift or move the lid upwardly relative to the formation 58, while the distributor is functioning, to visually check the operation of the distributor 10 while in use.

If desired the cap 50 can be eliminated by manufacturing formation 58 and tube section 32 from clear polymeric material. Thus instead of the formation 58 being open in sections, a completely closed surface can be used. In this way the formation 58 will act as a cover, locator and centraliser and an operator will be able to view the operation of the distributor 10 through the closed formation 58.

In use the distributor 10 will be supported above an apparatus or apparatuses which will receive liquid therefrom. The liquid enters into the distributor by inlet assembly 30 and this then flows with an even flow rate out of the outlets 18 by passing from the base of the central portion through the sieve of platen 42 and downwardly through apertures 40 into the chambers 16.

By the apertures 40 being at approx 40% (although somewhere between 30% and 60% will suffice), it ensures that a supply of liquid to the base of the chambers 16 is readily supplied. If the level of liquid in central chamber is higher than platen 48, this will not hinder or impede the flow out of the outlets 18.

By the apertures 40 being in a horizontal surface it is expected that this will decouple or separate the distributor's metering function via the apertures 40 from being adversely affected by liquid entering the fluid passageways or outlets 18. By this means the apertures 40 and outlets 18 won't influence each other and hence an equal distribution is more likely to be achieved in each distribution chamber 16.

The apertures 40, by being located well beneath the upper rim of the central chamber 20, and being relatively large, may also make the distributor 10 less prone to dirt clogging that may otherwise occur with the use of fine slots as in the prior art, which can be a consideration when used with slurry and dirty wash water.

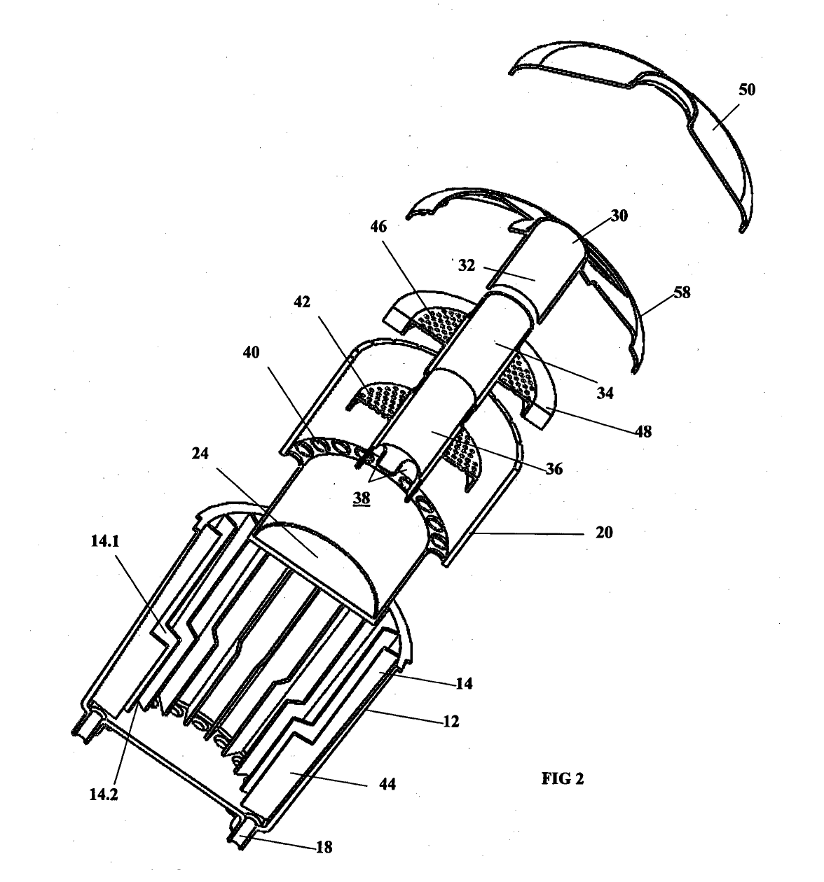

In the embodiments of FIGS. 1 to 7, the distribution chambers are open at their top to allow venting of air. This assists to prevent or minimise syphoning occurring at the chamber outlets 18, as such syphoning can impair the operation of the distributor, by resulting in more slurry or wash water passing through some outlets than others, which may be caused by variable length tubes being connected to the outlets 18. In this way the embodiment of FIGS. 1 to 7 can produce a generally even flow of slurry or wash water our of the outlets 18.

The distribution chambers 16 as described above have a larger volume at their bottom or lower ends, which assists in the distributor 10 having a compact design as the upper end of the chambers 16 need have a reduced cross sectional area for air venting purposes.

In the above description the outer housing 12 and central chamber 20, are described as being manufactured from two separate parts which require assembly. This allows the central chamber 20 to be removed and emptied in use by an operator, as solids may settle out in the bottom of the central chamber, given that dirty water or slurry is used.

The apertures 40 are illustrated as being circular apertures, however, if desired the apertures 40 can be shaped as the segment of a circle where the cross sectional area of the opening of the aperture 40 will be bounded by a segment of the circumference of the inner surface of upper section 21 and the outer surface of the lower section 28, and between side radial surfaces which will be adjacent the facing surfaces of adjacent walls 14. By this means a full width aperture is formed, with respect to the arc width of each distribution chamber 16 in the vicinity of the aperture.

In the above description the lower section 14.2 of the walls 14 are described as abutting or contacting the smooth surface of the outer circumference of lower section 28 of central chamber 20. If desired, the outer circumference of lower section 28 of central chamber 20 can include slots which are sized and shaped so as to receive the radially inner edge of the lower section 14.2 of walls 14.

The distributor 10 is preferably manufactured from polymeric materials and is preferably made from injection moulded components. By manufacturing the components of the distributor 10 from clear polymeric materials, this will assist operators in viewing the operation and functioning of the distributor. However, any appropriate material or manufacturing technique can be used.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A distributor for distribution of a liquid to a mineral processing apparatus, the distributor including a housing formed by an outer wall and a central chamber formed by an inner wall and located in said housing, said central chamber being adapted to receive said liquid for distribution to distribution chambers located between the outside of said central chamber and an internal surface of said housing, characterised in that passage from said central chamber to respective ones of said distribution chambers is by means of respective apertures which are formed through a generally horizontally oriented surface formed as part of said inner wall.

2. A distributor as claimed in claim 1, wherein said distribution chambers have a wider base section compared to their upper sections.

3. A distributor as claimed in claim 1, wherein said distribution chambers are of similar or the same size and are equally angularly spaced around said central chamber.

4. A distributor as claimed in claim 1, wherein said housing is formed with radially inwardly projecting walls which will, in a final assembly, form walls separating said distribution chambers.

5. A distributor as claimed in claim 4, wherein said inner wall which forms said central chamber includes axially and or radially extending complementary shaped grooves to receive free ends of said radially inwardly projecting walls of said housing to thereby form said distribution chambers.

6. A distributor as claimed in claim 1, wherein there is provided a central inlet tube which delivers to a base of said central chamber said liquid.

7. A distributor as claimed in claim 6, wherein said central inlet tube is assembled from two or more tube parts.

8. A distributor as claimed in claim 6, wherein the base of said central inlet tube includes horizontally directed openings for liquid to travel out of said inlet tube into said central chamber.

9. A distributor as claimed in claim 6, wherein a flow path of said liquid into said central chamber is such that the liquid must pass through one or more cavities before accessing said apparatus.

10. A distributor as claimed in claim 10, wherein the one or more cavities are radially spaced around the central inlet tube.

11. A distributor as claimed in claim 9, wherein said apertured platens provide one or more sieve formulations.

12. A distributor as claimed in claim 1, wherein said apertures are located between 30% and 60% of the height of said inner wall.

13. A distributor as claimed in claim 1, wherein said liquid exits said distribution chambers from a location in the base of said distribution chambers.

14. A distributor as claimed in claim 1, wherein said liquid distributed can be any one or more of the following: slurry of mineral to be processed; washing liquid.
